(19) United States
(12) Patent Application Publication
(10) Pub. No.: US 2007/0009184 A1
(43) Pub. Date: Jan. 11, 2007

(54) Associating attributes to captured input within a digital pen

(76) Inventors: Kulvir Singh Bhogal, Fort Worth, TX (US); Gregory Jensen Boss, American Fork, UT (US); Rick Allen Hamilton II, Charlottesville, VA (US); Alexandre Polozoff, Bloomington, IL (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/174,961

(22) Filed: Jul. 5, 2005

(51) Int. Cl. G06K 9/22

(52) U.S. Cl. 382/314

(57) ABSTRACT

Methods, systems, and media are disclosed for altering the captured input within a digital pen. One embodiment includes capturing the input by the digital pen, wherein the input comprises dots and measurements. Further, the method includes modifying, within the digital pen, the input based on an attribute selected for the input, wherein the modifying produces a modified input. Such modifying may occur by conversion functions, such as to a preferred input format, e.g., Excel® spreadsheet, or a preferred stylistic format, e.g., black 12 point font, wherein the conversion functions modify the input to affect such preferences based on a position of one or more selectors located on the exterior of the digital pen. Finally, the method includes transmitting the modified input to a computer system in wireless communication, for example, with the digital pen.

### FIELD OF INVENTION

The invention generally relates to digital pens, and, in particular, to devices, methods, and media for altering the captured input within a digital pen to yield a modified input as output.

### BACKGROUND

Like conventional pens, digital pens, such as Logitech's® io₂ and Nokia's® SU-1B, often find use in note-taking. Furthermore, many conventional and digital pens begin the writing process the same way; that is, by taking off the pen's cap—an on/off switch for many digital pens. In addition, many digital pens also contain ink cartridges, so that the user can see its writing. Digital pens importantly differ, however, from conventional pens in that a digital pen records the user's ideas, sketches, and notes in digital form. Normally, digital pens include a tiny camera within an optical sensor for capturing the pen's movements made by the pen's pressure-sensitive tip across a specialized surface, whereby the pen stores these movements as a series of map coordinates in non-volatile flash memory, e.g. 2 MB in size. The specialized surface, itself, is usually a gridded or dotted paper surface, which is generally called “digital paper.” However, the surface could be larger than ordinary paper, such as chalkboard or whiteboard size. Regardless the size of the specialized surface, the pen and specialized surface interplay is the same: the pen captures the coordinates that correspond to the exact location on the specialized surface, such as a page. The pen's processor then digitizes the pen's dots and measurements, which correspond to written words and drawn images for ultimate display and storage, for example, on a computer system in communication with the pen.

Returning to the above-described capturing, the pen naturally captures what it sees. For instance, suppose the captured text or graphics is actually green and blue. The pen, expectedly, will capture the same text or graphics as green and blue. If the user wishes to modify the pen's realistic capture of the text's or graphics' colors, say, for instance, to red and purple, then, the state of the art requires software post-processing, e.g., MyScrip® Notes, of the text or graphics. As is, the captured data is normally imported into a workstation for manipulation of such text or graphics. This cumbersome importation required for manipulation of a digital pen's captured input is tedious and time-consuming for the user, as well as being error prone in two respects, namely user and system.

A need, therefore, exists for devices, methods and media for altering a digital pen's captured input that avoids the cumbersome, tedious, time-consuming, and error-prone software post-processing approach.

### SUMMARY OF THE INVENTION

Embodiments of the invention generally provide methods, systems, and media for altering the captured input within a digital pen. In one embodiment, the method includes capturing the input by the digital pen, wherein the input comprises dots and measurements. Further, the method includes modifying, within the digital pen, the input based on an attribute selected for the input, wherein the modifying produces a modified input. Such modifying may occur by conversion functions, such as to a preferred input format, e.g., Excel® spreadsheet, or a preferred stylistic format, e.g., black 12 point font, wherein the conversion functions modify the input to affect such preferences based on a position of one or more selectors located on the exterior of the digital pen. Finally, the method includes transmitting the modified input to a computer system in wireless communication, for example, with the digital pen.

In another embodiment, the invention provides a digital pen having an interior portion and an exterior portion. The digital pen also includes an optical sensor, protruding from the interior portion to the exterior portion, for reading input, wherein the input comprises dots and measurements. In addition, the digital pen includes memory, in the interior portion and in communication with the optical sensor, for capturing the input read by the optical sensor. Furthermore, the digital pen includes one or more selectors located on the exterior portion, wherein the position of the one or more selectors sets one or more attributes for applying to the input. The digital pen further includes an application, in the interior portion and in communication with the memory, wherein the application modifies the input based on the position of the one or more selectors in order to produce a modified input. Finally, the digital pen includes a processor, in the interior portion and in communication with the optical sensor, the memory, the one or more selectors, and the application.

In yet another embodiment, the invention provides a machine-accessible medium containing instructions for altering the captured input within a digital pen, which when executed by a machine, cause the machine to perform operations. The instructions generally include operations for capturing the input by the digital pen, wherein the input comprises dots and measurements. The instructions further include operations for modifying, within the digital pen, the input based on an attribute selected for the input, wherein the modifying produces a modified input. Finally, the instructions further include operations for transmitting the modified input to a computer system in wired or network communication, for example, with the digital pen.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an embodiment of a digital pen in accordance with the disclosed invention.

FIG. 2 depicts an embodiment of a digital pen in accordance with the disclosed invention.

FIG. 3A depicts an embodiment of a table drawn by a digital pen in accordance with the disclosed invention

FIG. 3B depicts an embodiment of input having the attribute of formatting the input captured by a digital pen for the table drawn in FIG. 3A in accordance with the disclosed invention.

FIG. 4 depicts an embodiment of a flowchart for of a digital pen in accordance with the disclosed invention.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, devices, methods, and media for altering the captured input within a digital pen are contemplated. Embodiments include a digital pen having a capturing movement reader, such as an optical sensor protruding from the bottom of the digital pen, much in the same way a ball point ink tip protrudes from a conventional ball point pen. In communication with the movement reader is memory within the digital pen to temporarily or permanently store the input, and hence, “capture” the input by the digital pen. Rather than using post-processing software to modify the captured image in the digital pen, disclosed devices, methods, and media, herein, modify the captured input within the digital pen. Whether reduced to hardware and/or software, enabling logic within the digital pen modifies the captured input with one or more attributes, such as those directed towards selected formatting and style for the captured input. The altered, captured input is then optionally saved within the digital pen or to an external device in communication with the digital pen, before transmitting the same to a computer system, for example, in communication with the digital pen, whereupon the altered image may be displayed on a monitor associated with the computer system.

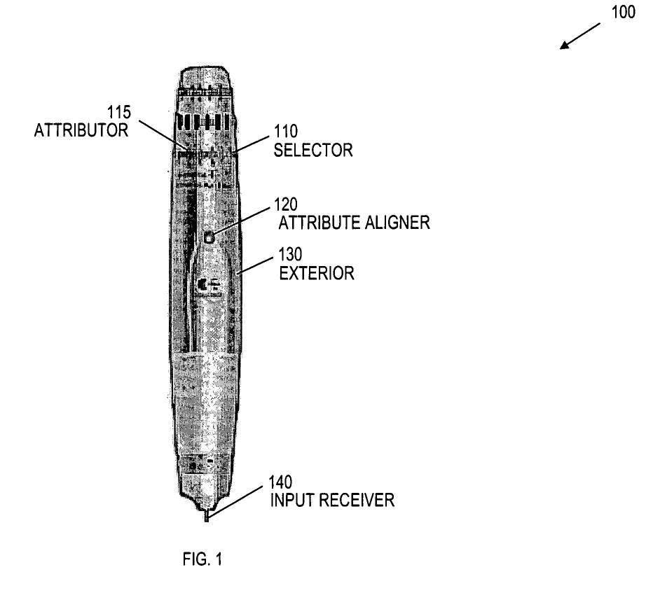

Turning now to FIG. 1, the appearance of a digital pen 100, in accordance with the invention, is disclosed. The digital pen 100 has an exterior 130 on which one or more selectors 110, one or more attributors 115, and an attribute aligner 120 appear. The selector 110, for example, is a slidable or rotatable tumbler, for adjustment by a user of the digital pen 100. Each selector 110 may be for a different attribute, such as one directed towards formatting or style, for application to captured input read by the input receiver 140 that acts on a capturing surface, such as a non-depicted digital pad. Depending on the optional design configuration of the digital pen 100, selectors 110 may be for application of the following example attributes to the input captured by the input receiver 140, which, for example, may be an optical sensor in combination with cameras: color, line thickness, line pattern (e.g., dotted, dashed), font size, font type (e.g., Times New Roman, Arial), boldness, language (e.g., English, French), italics, Excel® formatting, and so forth. The one or more attributors 115 on a specific selector 110 may operate for granular selection of a specific attribute, i.e., selection of a font size attributor 115 on a font size selector 110. In another embodiment, the attributors 115 on a specific selector 110 may permit granular selection capabilities for a specific selector 110 having more than one type of formatting and/or stylistic attribute. As described in more detail below, based on the attribute selected for the input captured by the digital pen 100, the input is modified within the digital pen 100 in accordance with the selected attribute.

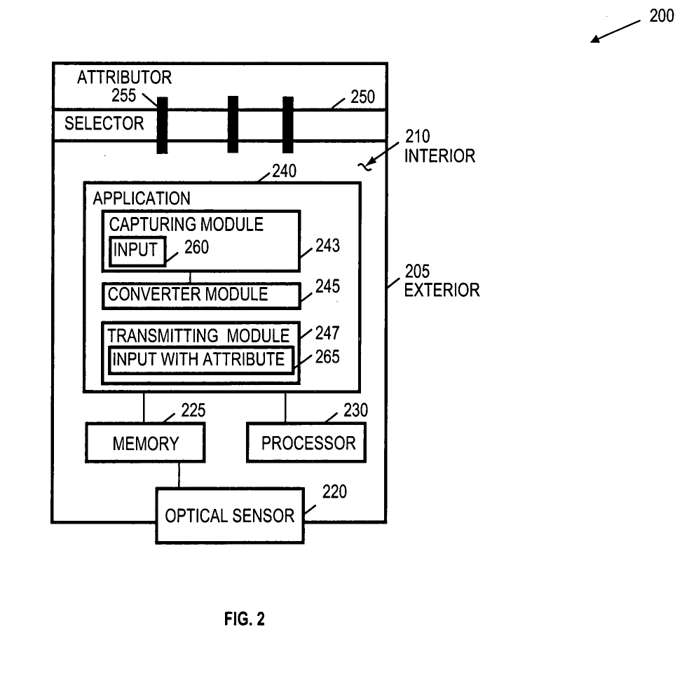

Now, moving to FIG. 2, a more detailed discussion of a digital pen 200 for altering the captured input 260 ensues by disclosing components in the interior 210 of the digital pen 200, as opposed to FIG. 1's focus on the exterior 205 of a digital pen 200.

The digital pen 200, for instance, includes an optical sensor 220 having a tiny camera, whereby a user moves the digital pen 200 in a conventional writing fashion over a digital surface, so that the optical sensor 220 captures the pen's 200 movements made by the pen's 200 pressure-sensitive tip across this surface, e.g., digital paper. In the depicted embodiment, the application's 240 capturing module 243 contains enabling logic reduced to code and/or hardware for capturing the input 260, i.e., a series of map coordinates, which is optionally stored in memory 225, such as non-volatile flash memory, e.g. 2 MB in size.

As with FIG. 1, FIG. 2 also shows attributors 255 on the selector 250, a matter which bears re-emphasis to ensure disclosure. The selector 250, for instance, may be one or more mechanical tumblers located in the interior 210 of the digital pen 200. In general, the mechanical tumble(s) allow a user to make a definitive selection among a host of selectable options. The definitive selection occurs, for instance, by the user sliding, twisting, or otherwise selectably moving the mechanical tumbler(s) located in the interior 210 of the pen 200. Alternate possible types of selectors include LED or LCD selector panel(s) located on the exterior 205 and in communication with the interior 210 application 240.

In this disclosure, a non-depicted tumbler is simply depicted as the selector 250 on the exterior 205 of the digital pen 200. Each attributor 255 merely adds granularity, that is, fine-tuning, for selecting a specific attribute assigned to the entire selector 250. In other embodiments, there may be no attributors 255; instead, simply one or more selectors 250. Still in other embodiments, the attributors 255 on a specific selector 250 may be for selectively differentiating between more than one attribute types of the specific selector 250. Regardless of how the digital pen 200 is actually configured with selectors 250 and/or attributors 255, in use, the tumbler(s) effectuate the user's selection of one or more attributes to assign to input 260 captured by the capturing module 243. The specific attributes, as previously discussed, may be color, line thickness, line pattern (e.g., hashed, underlining, double underlining), font size, font type (e.g., Tahoma), boldness, language (e.g., Russian to German), italics, Excel® formatting, and so forth. For instance, in regards to selecting a language, wherein the selecting may occur by appropriately setting one or more attributors 255 and/or a specific selector 250, enabling logic may inform a word processor in the digital pen 200 what dictionaries to associate with the captured input 260 for modification into the selected language by the converter module 245.

With captured input 260, the application's 240 converter module 245 now modifies the input 260 to be the input with attribute 265, which is the converter module 245 modifying the input 260 to have the attribute(s) a user selectably chooses. Enabling logic, reduced to code and/or hardware, associated with the converter module 245, and enabled by the processor 230, permits the converter module 245 to understand and interpret the position of a tumbler pin, for instance, to mean convert the input 260 to input with attribute 265. After this conversion, the input with attribute 265 is optionally stored to memory 225 in the digital pen 200 before or after the application's 240 transmitting module 247 transmits the input with attribute 265. The transmitting module 247, having enabling logic in code and/or hardware, may transmit the input with attribute 265 by wired, wireless, or BlueTooth® communication, for instance, for visual display of the input with attribute 265 on a monitor associated with a computer system.

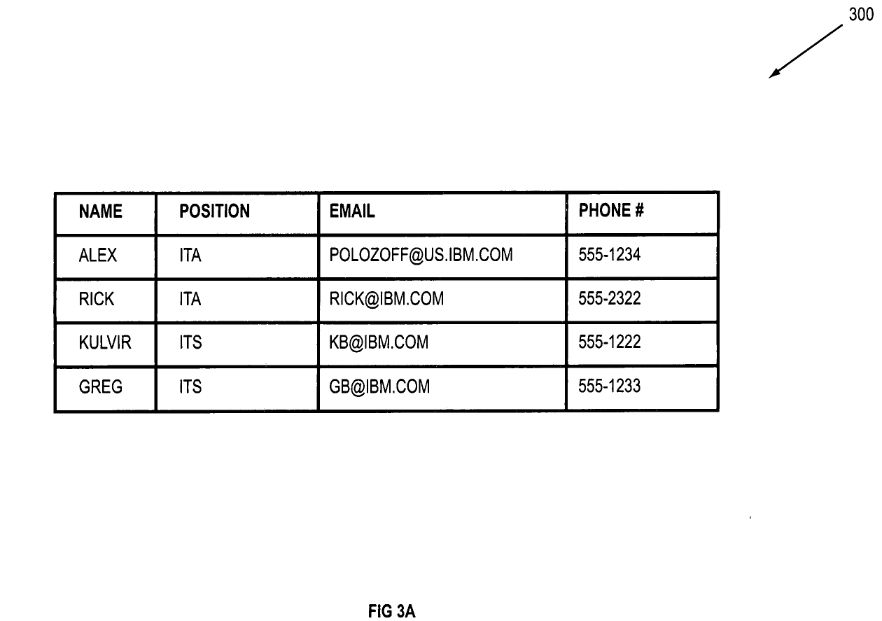

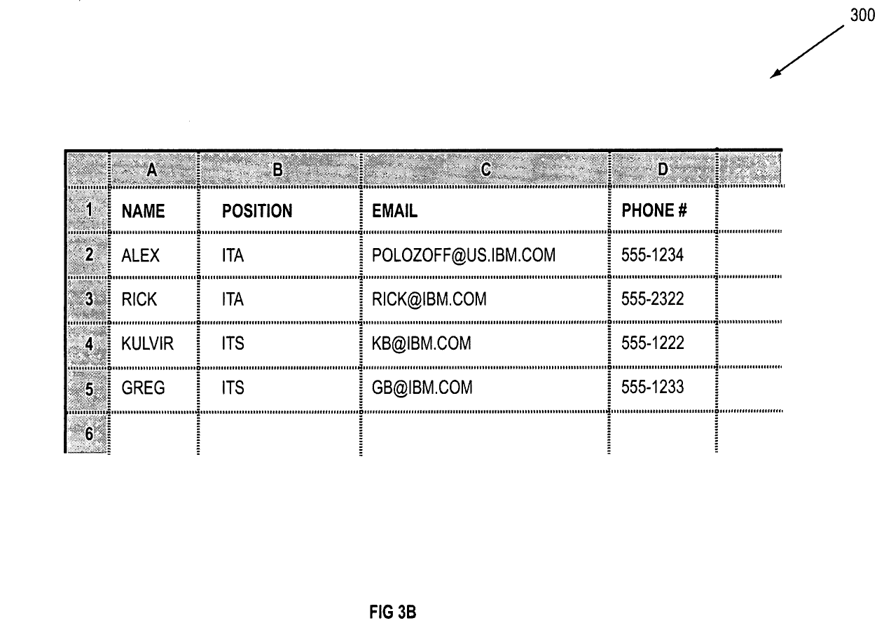

Focus now is directed to FIGS. 3A and 3B. These figures collectively show the before and after result for a user selecting an Excel® format attribute for modification of the input, i.e., a table drawn on a digitally responsive surface and captured by a digital pen. FIG. 3A shows input, i.e., a drawn table 300, before any modification. FIG. 3B shows the same input as that shown in FIG. 3A, but includes a modification with the selected formatting attribute of Excel® applied to that drawn table 300 of FIG. 3A in order to produce the Excel® formatted table 350 shown in FIG. 3B. FIGS. 3A and 3B display only one example for modifying captured input to have a selected input. Simpler, additional, non-depicted examples of altering captured input with an attribute include: selecting a black font attribute for captured blue font, and a much simpler; selecting a 12-point size font attribute for all captured font; and selecting the French language for captured Greek input, and a much simpler.

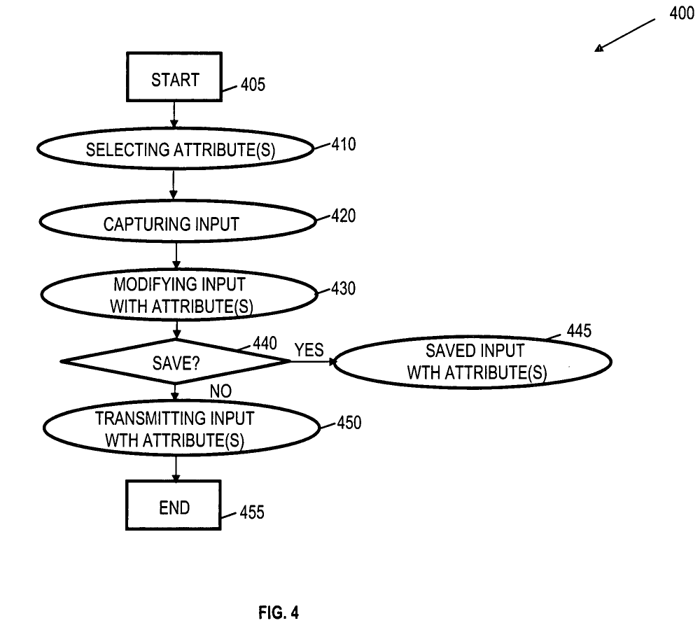

Turning now to FIG. 4, another aspect of the invention is disclosed. In particular, an embodiment of a flowchart 400 for altering the input within a digital pen is depicted. Flowchart 400 is for a device, such as devices 100 and 200, as shown in FIG. 1 and FIG. 2.

Flowchart 400 starts 405 by a user, for instance, selecting 410 one or more attributes, as previously discussed, for captured input by a digital pen. Selecting 410 may occur by a user moving one or more selectors located on the exterior of the digital pen, wherein the selecting 410, for example, includes twisting, engaging, turning, sliding, or pushing. For selecting 410, the user may move a band, for example, attached to a tumbler located in the interior of the digital pen, wherein the band may have one or more adjustable components that align with a selection point in order to set the digital pen to a chosen attribute for ultimate application to input captured 420 by the digital pen. In alternative embodiments, the selecting 410 may occur either before or after capturing 420 the input by the digital pen.

Like the selecting 410, an application residing within the digital pen provides enabling logic, whether reduced to code and/or burned to a chip, for capturing 420 the input from a digital pen acting on a responsive surface, e.g., digital paper. In one embodiment, the capturing 420 occurs by an optical sensor with a camera reading the movements on a digital surface, whereby the movement coordinates are stored, and, hence, captured 420 in memory within the digital pen. The optical sensor and camera are affixed within to the interior of the digital pen, but both are positioned in such a manner so as to allow a viewable area when the digital pen's pressure-sensitive tip acts on a digitally responsive surface.

Moving down the flowchart 400, the application's enabling logic modifies 430 the input after its capture 420 in accordance with the application's interpreted position of a selector for the selected 410 attribute(s). As a result, the application modifies 430 the captured 420 input to produce the input to apply the selected 410 attribute, as previously described. At this point, the flowchart 400 then queries whether to save 440 the modified 430 input with the attribute(s). This optional query 440 may occur by engaging a switch, for instance, located on the exterior of the digital pen, wherein setting the switch in one of two opposing positions is for saving 445 the input with the attributes (i.e., post-modification input), shown as a “yes” on FIG. 4 to the save 440 query. Otherwise, the answer to the optional saving query 440 is “no,” and the flowchart 400 continues towards the end 455.

The flowchart 400 culminates with the application's enabling logic, reduced to code and/or hardware, transmitting 450 the input modified 430 with the attribute(s) selected 410 by the user. The transmitting 450, in alternate embodiments, occurs by the digital pen's application sending the input modified 430 with the attribute(s) via wired or wireless communication to a viewing device, such as a monitor associated with a computer system.

Another embodiment of the invention is implemented as a program product for use within a device such as, for example, devices 100 and 200 shown in FIG. 1 and FIG. 2. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

What is claimed is:

1. A method for altering input within a digital pen, the method comprising:
capturing the input by the digital pen, wherein the input comprises dots and measurements;
modifying, within the digital pen, the input based on an attribute selected for the input, wherein the modifying produces a modified input; and
transmitting the modified input.

2. The method of claim 1, further comprising selecting, on the digital pen, the attribute for the modifying.

3. The method of claim 2, wherein the selecting comprises turning a selector for the attribute.

4. The method of claim 2, wherein the selecting comprises sliding a selector for the attribute.

5. The method of claim 1, wherein the modifying further comprises implementing a conversion function based on the attribute selected for the input.

6. The method of claim 1, wherein the capturing comprises reading, by the digital pen, the input based on the digital pen acting on a capturing surface.

7. The method of claim 1, wherein the transmitting comprises transmitting the modified input to a computer system in communication with the digital pen.

8. A digital pen, comprising:
an interior portion and an exterior portion of the digital pen;
an optical sensor, protruding from the interior portion to the exterior portion, for reading input, wherein the input comprises dots and measurements;
memory, in the interior portion and in communication with the optical sensor, for capturing the input read by the optical sensor;
one or more selectors located on the exterior portion, wherein the position of the one or more selectors sets one or more attributes for applying to the input;
an application, in the interior portion and in communication with the memory, wherein the application modifies the input based on the position of the one or more selectors in order to produce a modified input; and
a processor, in the interior portion and in communication with the optical sensor, the memory, the one or more selectors, and the application.

9. The digital pen of claim 8, wherein the one or more selectors comprise a set of tumblers located in the interior portion.

10. The digital pen of claim 8, wherein the application comprises converter module for converting the input into the modified input based on the position of the one or more selectors.

11. The digital pen of claim 8, wherein the application comprises a capturing module for reading, by the digital pen, the input based on the digital pen acting on a capturing surface.

12. The digital pen of claim 8, wherein the application comprises a transmitting module for transmitting the modified input to a computer system in communication with the digital pen.

13. The digital pen of claim 8, wherein the one or more attributes comprises a formatting attribute.

14. The digital pen of claim 8, wherein the one or more attributes comprises a stylistic attribute.

15. The method of claim 1, wherein the modifying further comprises implementing a conversion function based on the attribute selected for the input.

16. A machine-accessible medium containing instructions, which when executed by a machine, cause the machine to perform operations for altering input within a digital pen, comprising:
capturing the input by the digital pen, wherein the input comprises dots and measurements;
modifying, within the digital pen, the input based on an attribute selected for the input, wherein the modifying produces a modified input; and
transmitting the modified input.

17. The machine-accessible medium of claim 16, wherein the instructions further comprise operations for selecting, on the digital pen, the attribute for the modifying.

18. The machine-accessible medium of claim 16, wherein the instructions for selecting comprise instructions for performing operations for selecting comprises turning a selector for the attribute.

19. The machine-accessible medium of claim 16, wherein the instructions for selecting comprise instructions for performing operations for selecting comprises sliding a selector for the attribute.

20. The machine-accessible medium of claim 16, wherein the instructions further comprise operations for implementing a conversion function based on the attribute selected for the input.
